(19) United States
(12) Patent Application Publication
(10) Pub. No.: US 2023/0291268 A1
(43) Pub. Date: Sep. 14, 2023

(54) HYDRAULIC PRESSURE CONTROL DEVICE

(71) Applicant: ADVICS CO., LTD., Kariya-shi, Aichi-ken (JP)

(72) Inventors: Keisuke KIMURA, Kariya-shi, Aichi-ken (JP); Nozomu SUMITOMO, Kariya-shi, Aichi-ken (JP)

(73) Assignee: ADVICS CO., LTD., Kariya-shi, Aichi-ken (JP)

(21) Appl. No.: 18/040,530

(22) PCT Filed: Aug. 27, 2021
(86) PCT No.: PCT/JP2021/031605

§ 371 Date: Feb. 3, 2023

(30) Foreign Application Priority Data
Aug. 31, 2020 (JP) 2020-145227

(51) Int. Cl. H02K 5/10; F15B 15/20; F16J 15/14

(52) U.S. Cl. CPC H02K 5/10; F15B 15/20; F16J 15/14

(57) ABSTRACT

A hydraulic pressure control device includes an electric motor including a motor main body portion, a conductive portion connecting a cavity of a substrate and the motor main body portion, and a covering portion covering a part of the conductive portion; a housing in which a through-hole for accommodating the covering portion is formed; a cap having a terminal insertion hole through which a motor terminal, which is a distal end portion of the conductive portion exposed from the covering portion, is inserted, and being fitted into the through-hole; and a seal member which is a cured product of a liquid sealing agent disposed between the cap and the covering portion to close the through-hole.

### TECHNICAL FIELD

The present disclosure relates to a hydraulic pressure control device.

### BACKGROUND ART

The hydraulic pressure control device includes, for example, an electric motor, a pump driven by the electric motor, and a substrate connected to the electric motor. The electric motor and the substrate are connected through a wiring unit including a conductive portion (bus bar) and a covering portion covering the conductive portion. Since the hydraulic pressure control device is a device that handles fluid, ensuring of sealing property with respect to the substrate is required. For example, in a brake pressure control device disclosed in Japanese Laid-Open Patent Application No. 2020-1417, an annular seal member is disposed on an outer peripheral surface of the covering portion of the wiring unit accommodated in a through-hole. This suppresses leakage of the fluid from the gap between the covering portion and the housing in the through-hole.

### CITATIONS LIST

### Patent Literature

Patent Literature 1: JP 2020-1417 A

### SUMMARY

### Technical Problems

In the above configuration, a gap is formed inside the wiring unit, that is, between the conductive portion and the covering portion in manufacturing. Therefore, for example, there is a possibility that the fluid that has entered the motor main body portion from the pump leaks out to the substrate side through the gap inside the wiring unit. That is, there is room for improvement in the above configuration from the viewpoint of sealing property with respect to the substrate. In addition, in a case where a plurality of terminals are connected to a cavity (connector) of a substrate, the connection work becomes complex if positional displacement (deflection) occurs in the terminals.

An object of the present disclosure is to provide a hydraulic pressure control device capable of improving sealing property with respect to a substrate and improving connection workability.

### Solutions to Problems

A hydraulic pressure control device according to the present disclosure includes: an electric motor having a motor main body portion, a conductive portion that connects a cavity of a substrate and the motor main body portion, and a covering portion that covers a part of the conductive portion; a housing in which a through-hole that houses the covering portion is formed; a cap that has a terminal insertion hole through which a motor terminal that is a tip portion of the conductive portion exposed from the covering portion is inserted and is fitted into the through-hole; and a seal member that is a cured product of a liquid sealing agent disposed between the cap and the covering portion so as to close the through-hole.

### Advantageous Effects of Disclosure

According to the present embodiment, as a result of utilizing fluidity at the time of disposing the seal member, a gap (internal gap) between the conductive portion and the covering portion is filled with the seal member. Therefore, fluid leakage to the substrate through the internal gap is suppressed. Since the seal member is disposed so as to close the through-hole, a gap (external gap) on the outer peripheral side of the covering portion in the through-hole is also filled with the seal member. That is, according to the present disclosure, the internal gap and the external gap are filled with the seal member, and the sealing property with respect to the substrate is improved.

Furthermore, the motor terminal is positioned by the terminal insertion hole of the cap. As a result, since the positional displacement (deflection) of the motor terminal is suppressed, the connecting work between the motor terminal and the cavity is facilitated. In addition, positioning (position adjustment) of the covering portion in the through-hole is also facilitated. Therefore, for example, the flow of the fluid through the external gap can be suppressed by adjusting the position so that the external gap becomes uniform (i.e., so that a large gap is not formed at one part).

### BRIEF DESCRIPTION OF DRAWINGS

FIG. 1 is a configuration diagram (cross-sectional view) of a hydraulic pressure control device according to the present embodiment.

FIG. 2 is a configuration diagram illustrating a wiring unit of the present embodiment when a seal member is seen through from one side in the axial direction.

FIG. 3 is a configuration diagram of a cap before assembly according to the present embodiment as viewed from the other side in the axial direction.

### DESCRIPTION OF EMBODIMENT

Hereinafter, an embodiment of the present disclosure will be described based on the drawings. Each drawing used for description is a conceptual diagram. In the present embodiment, a specific configuration will be described using a hydraulic pressure control device (e.g., an actuator) used in a brake system of a vehicle by way of an example.

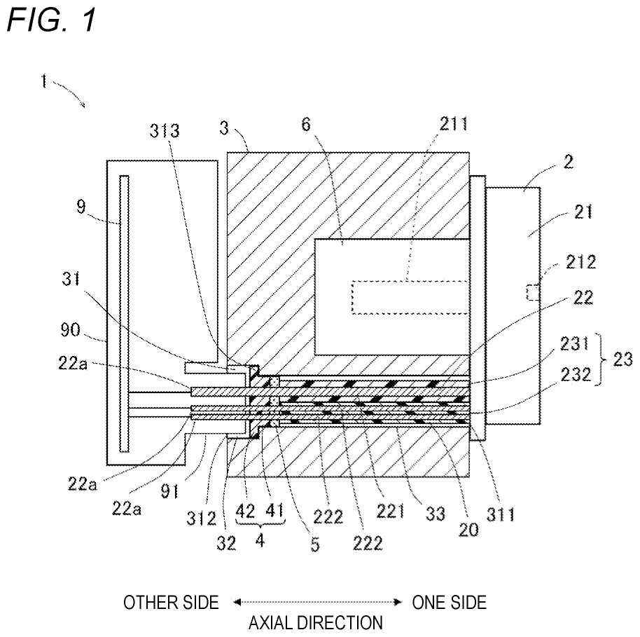

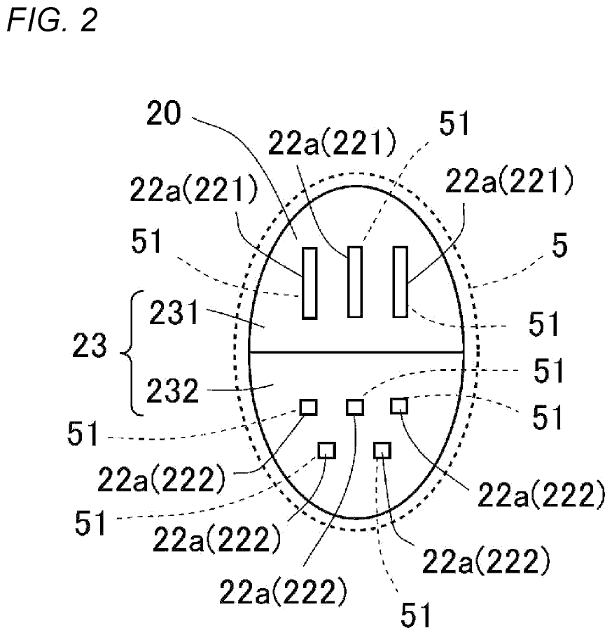

As illustrated in FIGS. 1 and 2, the hydraulic pressure control device 1 of the present embodiment includes an electric motor 2, a housing 3, a cap 4, a seal member 5, and a pressure adjusting device 6. The electric motor 2 drives the pressure adjusting device 6. The electric motor 2 is, for example, a brushless motor. The electric motor 2 includes a motor main body portion 21, a conductive portion 22, and a covering portion 23. The motor main body portion 21 includes an output shaft 211, a rotor (not illustrated), a stator (not illustrated), a rotation angle sensor 212, and the like.

The conductive portion 22 is a conductor portion that connects the cavity 91 of the substrate 9 and the motor main body portion 21. The cavity 91 includes a resin and a female terminal, and is also called a connector. The conductive portion 22 is configured by a plurality of bus bars. Specifically, the conductive portion 22 includes a plurality of (here, three) power lines 221 for supplying power to the motor main body portion 21 and a plurality of (here, five) signal lines 222 for transmitting a rotation angle signal of the motor main body portion 21. The signal line 222 connects the rotation angle sensor 212 and the substrate 9.

The covering portion 23 is a member that covers a part of the conductive portion 22. The covering portion 23 is formed of, for example, resin (mold resin). More specifically, the covering portion 23 includes a first covering portion 231 that covers the power line 221 and a second covering portion 232 that covers the signal line 222 separately from the first covering portion 231. Since different types of wiring are formed separately in terms of manufacturing, the first covering portion 231 and the second covering portion 232 are separate bodies. The wiring shape is maintained by the covering portion 23, and insertion into the through-hole 31 is facilitated. The covering portion 23 exhibits a guide function at the time of assembly of the electric motor 2. The covering portion 23 can be said to be a terminal guide that guides a motor terminal 22a to be described later.

The conductive portion 22 and the covering portion 23 configure a wiring unit 20. That is, the electric motor 2 includes the motor main body portion 21 and the wiring unit 20. A distal end portion of the conductive portion 22 exposed from the covering portion 23 is connected to the motor terminal 22a which is a female terminal of the cavity 91. The wiring unit 20 of the present embodiment includes the motor terminals 22a of the three power lines 221 and the motor terminals 22a of the five signal lines 222.

The housing 3 is a metal block. The housing 3 is formed with a hydraulic circuit, and is arranged with the electric motor 2, the pressure adjusting device 6 driven by the electric motor 2, an electromagnetic valve (not illustrated), and the like. The pressure adjusting device 6 is a device that adjusts a hydraulic pressure (e.g., a hydraulic pressure of a wheel cylinder). The pressure adjusting device 6 of the present embodiment is a pump.

The electric motor 2 is disposed on one end side of the housing 3, and the substrate 9 is disposed on the other end side of the housing 3. The substrate 9 includes a CPU, a memory, and the like, and constitutes a brake ECU that controls the electric motor 2 and the electromagnetic valve. The substrate 9 is fixed to an ECU case 90 including a cavity 91.

Each motor terminal 22a is connected to the substrate 9 by way of the cavity 91. The power is supplied to the motor main body portion 21 through the substrate 9 and the power line 221 of the wiring unit 20. The rotation angle signal output from the rotation angle sensor 212 is transmitted to the substrate 9 via the signal line 222 of the wiring unit 20. For example, a breathing hole (not illustrated) is provided in the housing 3.

A through-hole 31 for accommodating the covering portion 23 is formed in the housing 3. The through-hole 31 extends from one end face to the other end face of the housing 3. The motor main body portion 21 is disposed near the one end side opening 311 of the through-hole 31, and the cavity 91 is disposed near the other end side opening 312 of the through-hole 31.

Hereinafter, the extending direction of the through-hole 31 is referred to as an “axial direction”. Furthermore, a direction from the other end side opening 312 toward the one end side opening 311 is defined as one side in the axial direction, and a direction from the one end side opening 311 toward the other end side opening 312 is defined as the other side in the axial direction. In the present embodiment, the axial direction and the extending direction of the output shaft 211 are parallel.

Near the other end side opening 312 of the through-hole 31, a step surface 313 extending in a direction intersecting the axial direction (here, the orthogonal direction) is formed so that a passage cross-sectional area increases at the other end in the axial direction. That is, the through-hole 31 includes a large diameter portion 32 forming the other end side opening 312 and a small diameter portion 33 extending to one side in the axial direction from the large diameter portion 32. A part of the cavity 91 is disposed in the large diameter portion 32.

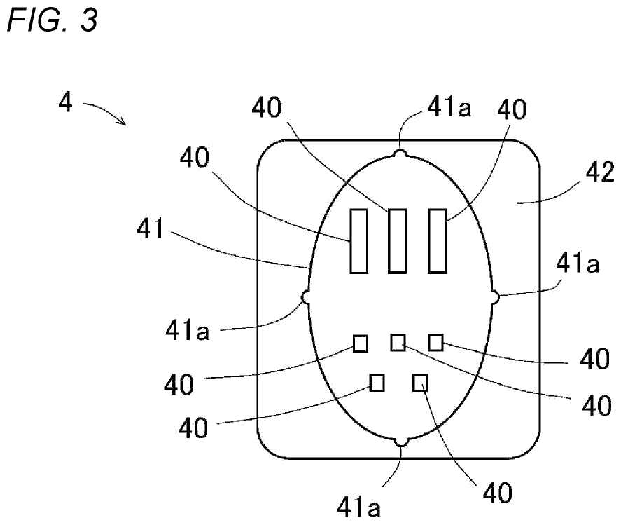

The cap 4 is a plug member having a terminal insertion hole 40 through which the motor terminal 22a is inserted, and being fitted into the through-hole 31. The cap 4 is made of, for example, resin. The cap 4 is fixed to the through-hole 31 so as to close the other end side opening 312. The motor terminal 22a of the power line 221 and the motor terminal 22a of the signal line 222 are respectively inserted into the individual terminal insertion hole 40. As illustrated in FIG. 3, three terminal insertion holes 40 for the power lines 221 and five terminal insertion holes 40 for the signal lines 222 are formed in the cap 4 of the present embodiment.

The cap 4 of the present embodiment includes a main body portion 41 in which the terminal insertion hole 40 is formed, and a flange portion 42 protruding from an outer peripheral surface of the main body portion 41. The main body portion 41 is formed in a shape (e.g., a columnar shape) adapted to the shape of the small diameter portion 33 of the through-hole 31. The one end in the axial direction of the main body portion 41 is press-fitted into the through-hole 31. A plurality of protrusions 41a for forming a press-fit margin are formed on the outer peripheral surface of the main body portion 41.

The flange portion 42 is formed at a position adjacent to a press-fit portion (one end in the axial direction) of the main body portion 41. One end face in the axial direction of the flange portion 42 is abutted on the step surface 313. In the present embodiment, a portion on the covering portion 23 side than the flange portion 42 of the main body portion 41 is disposed in the through-hole 31 in a state of pressing the housing 3. Note that the flange portion 42 of the present embodiment is formed in an annular shape, but may not be an annular shape, and may protrude from, for example, one part in the circumferential direction of the main body portion 41. The flange portion 42 may have a shape adapted to the shape of the large diameter portion 32.

The seal member 5 is a cured product of a liquid sealing agent disposed between the cap 4 and the covering portion 23 so as to close the through-hole 31. The seal member 5 can also be said to be a liquid sealing agent in a dry state (solidified liquid sealing agent). The liquid sealing agent can also be referred to as a liquid gasket. The liquid sealing agent may be, for example, silicon-based.

As a manufacturing process, after the wiring unit 20 is inserted into the through-hole 31 of the housing 3, the liquid sealing agent is applied from the other end side opening 312 to the other end in the axial direction of the covering portion 23 so as to close the through-hole 31. Thereafter, the motor terminal 22a is inserted into the terminal insertion hole 40 from the other end side opening 312, and the cap 4 is press-fitted into the through-hole 31. The liquid sealing agent has fluidity when applied, and solidifies when dried.

The seal member 5 abuts on the outer peripheral surface of each motor terminal 22a over the entire circumference. As illustrated in FIG. 2, as a result, the seal member 5 is formed with individual insertion holes 51 through which the motor terminals 22a are inserted in an abutted state. In FIG. 2, the wiring unit 20 through which the seal member 5 is seen is shown, and the seal member 5 is indicated by a dotted line.

The cap 4 prevents the liquid sealing agent from leaking out from the other end side opening 312 of the through-hole 31 at the time of the assembly work. The lowering in sealing property is thereby suppressed. In the present embodiment, the one end in the axial direction of the seal member 5 is abutted on the covering portion 232, and the other end in the axial direction of the seal member 5 is abutted on the main body portion 41 of the cap 4. That is, the seal member 5 of the present embodiment is filled between the cap 4 and the covering portion 23.

### Effects of the Present Embodiment

According to the present embodiment, as a result of utilizing fluidity at the time of disposing the seal member 5, a gap between the conductive portion 22 and the covering portion 23 (hereinafter referred to as a “first internal gap”) is filled with the seal member 5. Therefore, fluid leakage to the substrate 9 through the first internal gap is suppressed. Since the seal member 5 is disposed so as to close the through-hole 31, a gap on the outer peripheral side of the covering portion 23 in the through-hole 31 (hereinafter referred to as an “external gap”) is also filled with the seal member 5. That is, according to the present embodiment, the first internal gap and the external gap are filled with the seal member 5, and the sealing property with respect to the substrate 9 is improved.

Furthermore, the motor terminal 22a is positioned by the terminal insertion hole 40 of the cap 4. As a result, since the positional displacement (deflection) of the motor terminal 22a is suppressed, the connecting work between the motor terminal 22a and the cavity 91 is facilitated. In addition, positioning (position adjustment) of the covering portion 23 in the through-hole 31 is also facilitated. Therefore, for example, the flow of the fluid through the external gap can be suppressed by adjusting the position of the covering portion 23 so that the external gap becomes uniform. For example, a configuration in which a large gap is not formed in one part can be obtained by positioning the wiring unit 20 at the center of the through-hole 31 by the terminal insertion hole 40.

Furthermore, since the cap 4 is disposed so as to abut on the seal member 5, the gap formed in the terminal insertion hole 40 is also filled with the seal member 5. As described above, the cap 4 has a positioning function (centering function) of the wiring unit 20, a leak suppression function of the fluid, and a leak suppression function of the liquid sealing agent at the time of assembly.

In the case where the wiring unit 20 includes the plurality of power lines 221 and the plurality of signal lines 222 as in the present embodiment, the connecting work becomes complex when the positional displacement occurs in the motor terminal 22a. However, according to the present embodiment, each motor terminal 22a is positioned by the cap 4, and hence the connecting work between the motor terminal 22a and the cavity 91 is facilitated even when the wiring unit 20 has another type of wiring or a plurality of covering portions.

In addition, in a configuration in which the wiring unit 20 includes the plurality of covering portions 231 and 232, a gap (hereinafter also referred to as a “second internal gap”) may be formed between the respective covering portions 231 and 232. However, the second internal gap is also filled by applying the liquid sealing agent to the end of the covering portion 23, Therefore, the sealing property with respect to the substrate can be improved. Furthermore, the second internal gap can be maintained to a minimum (e.g., the covering portions 231 and 232 are in abutted state) by the positioning function of the cap 4.

Furthermore, the cap 4 of the present embodiment has a flange portion 42. Thus, when press-fitting the cap 4 into the through-hole 31, the flange portion 42 abuts on the step surface 313 or the end face of the housing 3, and the main body portion 41 can be stopped from entering at an appropriate position. The flange portion 42 functions as a stopper. According to this configuration, the assembly work of the cap 4 is facilitated.

### <Others>

The present disclosure is not limited to the embodiment described above. For example, the pressure adjusting device 6 is not limited to a pump, and may be an electric cylinder driven by the electric motor 2. The electric motor 2 may be, for example, a brush motor, and the wiring unit 20 may include only the power line 221. The number of covering portions 23 may be one (integrated). In addition, the flange portion 42 may not be provided. Furthermore, one end in the axial direction of the terminal insertion hole 40 may be formed in a tapered shape such that the passage cross-sectional area increases toward one side in the axial direction. The insertion work of the motor terminal 22a into the terminal insertion hole 40 is thereby facilitated. Furthermore, the seal member 5 and the cap 4 may not be abutted with each other. The press-fit margin of the main body portion 41 may not be formed by the protrusion 41a.

1. A hydraulic pressure control device comprising:
an electric motor including a motor main body portion, a conductive portion connecting a cavity of a substrate and the motor main body portion, and a covering portion covering a part of the conductive portion;
a housing in which a through-hole for accommodating the covering portion is formed;
a cap having a terminal insertion hole through which a motor terminal, which is a distal end portion of the conductive portion exposed from the covering portion, is inserted, and being fitted into the through-hole; and
a seal member which is a cured product of a liquid sealing agent disposed between the cap and the covering portion to close the through-hole.

2. The hydraulic pressure control device according to claim 1, wherein
the conductive portion includes a plurality of power lines for supplying power to the motor main body portion and a plurality of signal lines for transmitting a rotation angle signal of the motor main body portion;
the covering portion includes a first covering portion that covers the power line and a second covering portion that covers the signal line separately from the first covering portion; and
the motor terminal of the power line and the motor terminal of the signal line are respectively inserted into individual terminal insertion holes.

3. The hydraulic pressure control device according to claim 2, wherein
the cap includes a main body portion formed with the terminal insertion hole, and a flange portion protruding from an outer peripheral surface of the main body portion; and
a portion on the covering portion side than the flange portion in the main body portion is disposed in the through-hole in a state of pressing the housing.

4. The hydraulic pressure control device according to claim 1, wherein
the cap includes a main body portion formed with the terminal insertion hole, and a flange portion protruding from an outer peripheral surface of the main body portion; and
a portion on the covering portion side than the flange portion in the main body portion is disposed in the through-hole in a state of pressing the housing.
